(19) United States
(12) Patent Application Publication
(10) Pub. No.: US 2004/0152446 A1
(43) Pub. Date: Aug. 5, 2004

(54) Method for providing network access to a mobile terminal and corresponding network

(76) Inventors: Martyn DV Saunders, Maidstone (GB); Kenneth D Stacey, Ipswich (GB); Stephen a Ellis, Vienna (AT)

Correspondence Address: NIXON & VANDERHYE, PC, 1100 N GLEBE ROAD, 8TH FLOOR, ARLINGTON, VA, 22201-4714, US

(21) Appl. No.: 10/476,537

(22) PCT Filed: May 15, 2002
(86) PCT No.: PCT/GB02/02305

(30) Foreign Application Priority Data
May 24, 2001 (EP) 01304591.9

(51) Int. Cl. H04M 3/16

(52) U.S. Cl. 455/411; 455/403

(57) ABSTRACT

The invnetion provides secure access to applications such as intranet access and corporate e-mail systems from mobile terminals such as cellular telephones and Personal Digital Assistants (PDA) using Wireless Application Protocol (WAP) by using an identifier that is unique to the mobile terminal (either the handset itself or the Subscriber Information Module (SIM) card that is used in the handset). This is passed to the authentication systems used by the service provider after the conventional verification of username and password details. If the identifier matches the record held in the authentication database then the service provider returns a number of user-specific options, such as corporate e-mail, intranet access, inventory or ordering systems.

The invention relates to a method for allowing access to a private network from a mobile terminal, and in particular a mobile telephone.

Mobile telephones have become ubiquitous in Europe, North America, and the Asia-Pacific region, and in developing nations network operators are deploying mobile networks rather than fixed access networks. Mobile telephones have been a significant driver in the move from industrialised societies to information-based societies and this will gain momentum as users become able to access the Internet as well as making voice calls. Currently, large companies and organisations have large intranets and systems (such as email) to which access is controlled to authorised users using security mechanisms such as SecurlD cards. Secure access to intranets and similar systems will be required for authorised users having data-capable mobile telephones (or personal digital assistants with data communications capabilities) without the inconvenience associated with issuing and managing security tokens.

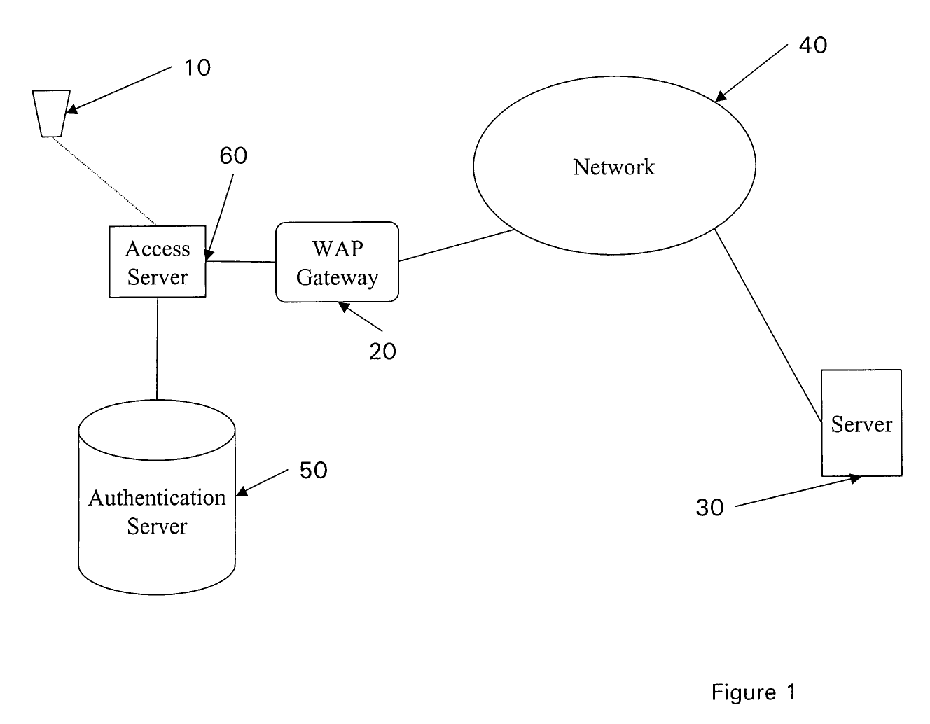

FIG. 1 shows a schematic view of a known network arrangement that allows users of suitably equipped terminals to access the Internet (or a private intranet). Each terminal 10 may establish a connection via a Network Access Server (NAS) 60 (and if necessary through a gateway 20 to translate between protocols) to a server 30 that is connected to the Internet 40. The network access server 60 validates the identity of the terminal 10 against an authentication server such as a Remote Authentication Dial-in User Server (RADIUS) 50.

The network access server 60 receives a dial-up call from each user device 10 requiring access to the network, and performs the necessary steps to authenticate and authorize each user, by checking the user name and password programmed into the device 10 against records held by the authentication server 50, before forwarding requests to the rest of the network. One of the most well known network access servers is the AS5800 made by Cisco Systems. Ascend (now Lucent) also provide very popular units.

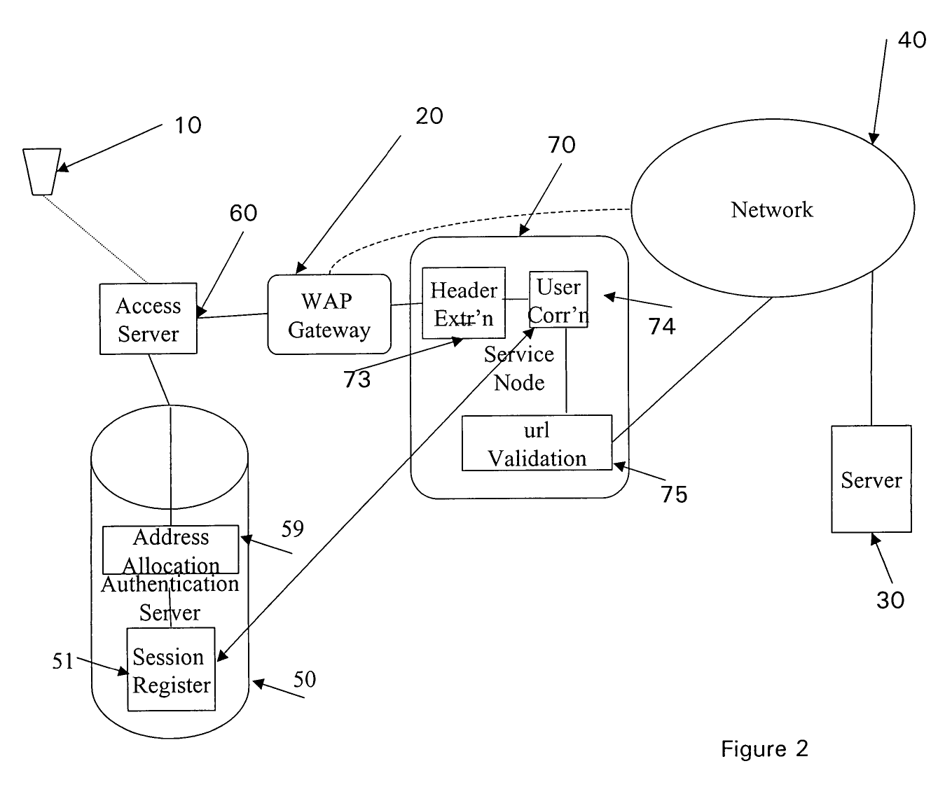

A suitable authentication server is the client/server protocol known as RADIUS, created by Livingston (now owned by Lucent), and now a de facto industry standard used by Ascend and other network product companies and proposed as an IETF standard. The RADIUS protocol enables remote access servers (NAS) 60 to communicate with a central server to authenticate dial-in users and authorize their access to the requested system or service. RADIUS allows user profiles to be maintained in a central database that all remote servers can share. The authentication server 50 authenticates the user and has an address allocation function 59 (see FIG. 2) that allocates an IP address to the user device. Accounting packets are sent at the start of the session, and when the user terminates the session.

The WAP Gateway 20 processes URL requests, and issues an HTTP request to fetch WML content from other web servers 30. Requests from the device 10 are translated into HTTP requests so that standard WWW servers may process them, and the received results are compiled and transmitted back to the device 10. If the device 10 is capable of handling http requests itself, the gateway 20 is not required.

When a terminal 10 attempts to connect to the NAS 60 it transmits a user identifier and an associated password using a handshake protocol such as the Challenge Handshake Authentication Protocol (CHAP). If the identifier and the password match a user record in the database of the authentication server 50, it assigns an IP address to the mobile terminal and the communication session is established. Typically, the terminal 10 holds the user identifier and the password in non-volatile memory and presents them to the NAS 60 automatically to authenticate the user. The user of a terminal 10 can then select the address of a server 30, or of a file held on such a server, by pressing a button on the terminal, causing the transmission of the required URL for the selected server or file. A field appears in the header section of the request specifying the browser's IP address, so that the reply can be routed back to the browser. In the case of a WAP browser the address that appears in this field is in fact the proxy address of the WAP gateway 20 through which the WAP browser 10 is working.

Mobile terminals do not have the hardware and processing capabilities of a personal computer, so they are not able to run an Internet browser such as Microsoft Internet Explorer or Netscape Navigator. Instead, the terminal 10 runs a microbrowser such as OpenWave Mobile Browser or the Nokia WAP browser. These microbrowsers use Extended Mark-up Language (XML) applications of which Wireless Mark-up Language (WML) and Hyper Text Mark-up Language (HTML) are examples. Rather than communicate with the gateway 20 using the conventional internet working protocols, such terminals communicate with a gateway using a group of protocols which are referred to as the Wireless Application Protocol (WAP) (see The Essential Guide to Wireless Communications Applications, A Dornan, published by Prentice Hall, pages 137-143 for an overview of the WAP protocol stack). WAP (Wireless Application Protocol) enables mobile terminals, such as suitably equipped mobile telephones, to access suitably-configured “World Wide Web” pages through a WAP gateway.

The WAP mobile terminal 10 sends the server (or file) request to the WAP gateway 20, which receives the request and then translates it into a conventional HTTP request for the URL (uniform request locator) specified in the request. The HTTP request is forwarded to the associated server 30, which then returns WML formatted content to the WAP gateway 20 along with an HTTP header. This content may be stored on the server 30 in a WML file or alternatively a script may be run to generate WML-formatted content from content MTML or some other format. The WAP gateway 20 receives the WML-formatted data, compiles it into the correct format (compiled WML) and sends the data to the mobile terminal 10. This data is received by the mobile terminal, which parses the WML code using the microbrowser and then displays the received contents on the terminal's display screen. When the WAP gateway 20 translates the requests that are sent to it from the terminal 10, it removes the mobile unit's assigned address from the requests and inserts the gateway's own IP address into the data packets that it transmits. This allows correct routing of the return packets. Thus it can be seen that the gateway 20 is acting as a proxy server in this regard.

Some WAP gateways also preserve the mobile unit's own IP address, or some other identifier such as the MSISDN of the originating terminal, by adding an additional field to the http header. This additional field is used in the present invention. Thus the server 30 still receives the user identification from the mobile terminal 10, but perceives the request to have originated from the gateway 20.

The WAP protocol stack is bearer-independent and thus it is possible for a mobile terminal 10 to use a wide range of level-2 (network layer) technologies to support WAP communication sessions. For second-generation mobile telephone technologies such as GSM and D-AMPS it is necessary for the mobile terminal to connect to a network access server 60 in order to be able to connect to the WAP gateway 20. For more advanced technologies, such as GPRS and UMTS, the mobile terminal may connect directly to the WAP gateway 20 through a router when initiating a session.

Systems are known, in which access to certain data is only permitted by way of a “firewall” server. The firewall has a list of IP addresses and associated access rights. Access to the controlled data is only permitted if the request is from one of the authorised addresses. However, as has already been stated, when a mobile terminal 10 attempts to connect to the NAS 60, the authentication server 50 assigns an IP address to the mobile terminal. On reconnection after a break a user will be allocated a new IP address, different from the one he had before. Moreover, IP addresses are re-used. Therefore IP addresses are not constant, and cannot be used on their own as an indicator of access rights of the user of that address. It would not be possible to simply replace the origin information (temporary IP address) in the header of the data request by the user identity, to allow the destination server to authenticate the user's identity, as the destination server also needs the temporary IP address to route the requested data back to the user (or the gateway to which the user is currently attached). Nor is it practical to add a further field to the header information, as the destination server is designed to obtain data for authentication and routing purposes from the same field.

According to a first aspect of the current invention secure network access is provided to a mobile terminal by a method comprising the steps of:

(a) receiving one or more terminal unique identifiers from the mobile terminal at an authentication server;

(b) generating a temporary network address for the mobile terminal

(c) storing the unique identifier and temporary network address; and

(d) when access to a network is requested by a mobile terminal through a proxy server, retrieving the stored unique identifier corresponding to the temporary network address of the mobile terminal making the request;

(e) searching a database for access rights associated with the retrieved terminal identifier;

(f) allowing the request to be forwarded if the access rights for the retrieved terminal identifier are compatible with the access request.

A proxy server normally acts as the browser to which the destination server appears to be connected, when it is in fact operating on behalf of another IP address. Normally the associated address is permanent, but in the present case the proxy server's relationship with IP addresses is variable, as the mobile users and their associated IP addresses change as the mobile units move around. The proxy server is therefore referred to herein as a “dynamic proxy server”.

Although the proxy server may handle requests from many different mobile terminals, each with different access rights (or none), the destination server can act on any data request received through the proxy server, since the proxy server itself will only pass on allowable requests.

The dynamic proxy server may validate the terminal-unique service identifiers against the authentication server either by authentication server ‘push’ to the proxy server, or by proxy server ‘pull’ from the authentication server. In other words, the authentication server may transmit the data to the dynamic proxy server in response to the initial connection process performed by the mobile terminal (“push” mode”), or only in response to a request for such data from the dynamic proxy server (“pull mode”).

The dynamic proxy server may communicate with the mobile terminal via a WAP gateway and the terminal may be a mobile telephone. The one or more terminal-unique identifiers received by the authentication server may be unique to the mobile terminal data carrier, for example the IMEI (International Mobile Station Equipment Identity) or to the SIM card that is held by the mobile terminal (for example the IMSI (International Mobile Subscriber Identity), the MSISDN (Mobile Station ISDN) or any other unique Identifier held by the terminal. Preferably the one or more unique identifiers received by the authentication server are unique to the user.

The network address conveyed to the dynamic proxy server may be associated with one or more terminal identifiers sent to the authentication server or alternatively the network address conveyed to the dynamic proxy server may be chosen from a defined range of addresses.

According to a second aspect of the present invention there is provided a communications network comprising

an authentication server having address allocation means for receiving data from a mobile terminal, said data comprising terminal-unique identifiers and allocating a temporary network address to the mobile terminal

storage means for storing the network address and the terminal-unique identifier for subsequent retrieval,

a dynamic proxy server, the dynamic proxy server having identification means, correlation means, and validation means

the identification means being arranged to identify the network address from which a data request originates,

the correlation means being arranged to search the database of network addresses and, if the search indicates a match, retrieve the terminal-unique identifier corresponding to the network address from the database,

and the validation means being arranged for searching a database for access rights associated with the retrieved terminal identifier, and forwarding the data request to the requested destination if the access rights for the retrieved terminal identifier are compatible with the access request.

The authentication server may be in communication with the dynamic proxy server such that, in use, the terminal-unique identifiers are communicated to the authentication server from the mobile terminal via the dynamic proxy server. Furthermore the network may further comprise a WAP gateway, which is in communication with the dynamic proxy server such that, in use, the mobile terminal communicates with the dynamic proxy server via the gateway.

The invention will now be described, by way of example only, with reference to the following figures in which:

FIG. 1 is a schematic depiction of a known arrangement that allows users of mobile terminals to access the internet, and has already been described;

FIG. 2 is a schematic depiction of a first embodiment of the present invention;

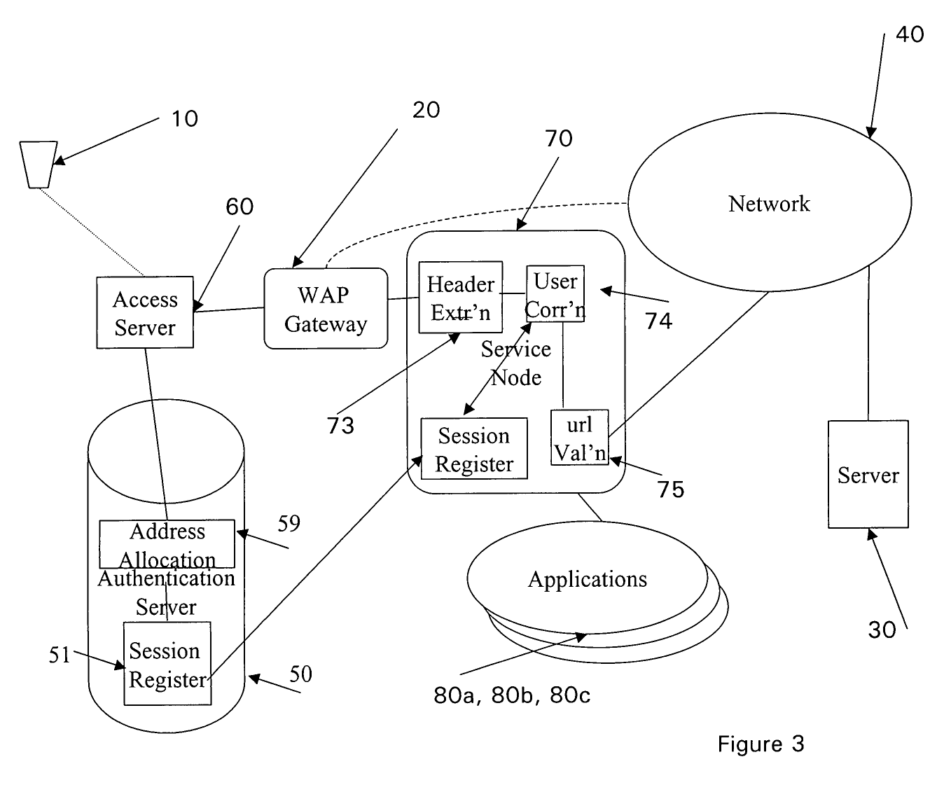

FIG. 3 is a schematic representation of a second embodiment of the present invention

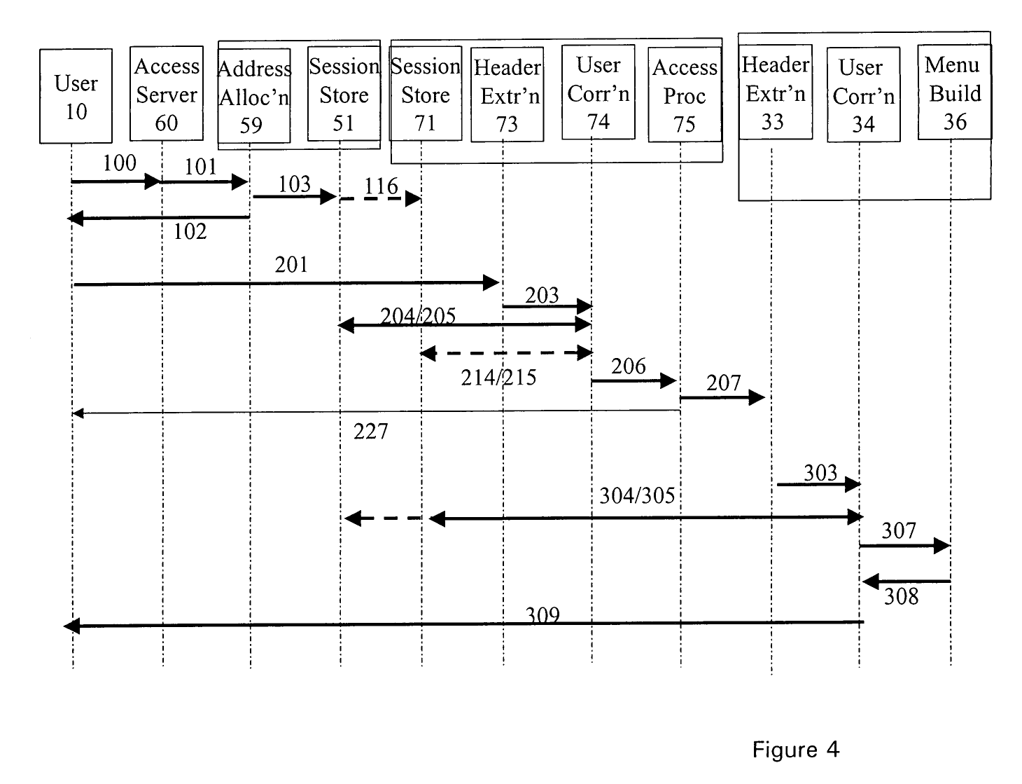

FIG. 4 is a flow chart indicating the information flows that take place in the embodiments of the invention.

In the embodiments depicted in FIGS. 2 and 3, the general arrangement is similar to that of FIG. 1, but a proxy server 70 is provided between the WAP gateway 20 and the network 40, to control access to parts of the network 40. In FIGS. 2 and 3 the server 30, authentication server 50 and proxy server 70 are shown in more detail than in FIG. 1.

The server 30 may be arranged to only respond to requests transmitted to it from the dynamic proxy server 70, requests from other IP addresses being rejected. Alternatively, the server 30 may accept requests from the dynamic proxy server 70 without authentication, but require authentication of requests from elsewhere. Such limitations may apply to the server 30 as a whole, or only to certain applications run by the server.

It is not necessary for the authentication server 50 to physically reside with the dynamic proxy server 70. It is only necessary for information within the accounting packets to be extracted and stored in an active sessions database 51, 71. This may be done in the authentication server 50 (FIG. 2) or in the dynamic proxy server 70 (FIG. 3).

The WAP gateway 20 routes data requests, received from users requiring access to the secure network 30, to this dynamic proxy server 70. Users not requiring access to the secure network can be given access to the internet 40 in the conventional way, without the use of the dynamic proxy server 70, as shown by the dotted lines in FIGS. 2 and 3.

In FIG. 2, the dynamic proxy server 70 retrieves data from an active session register 51 associated with the authentication server 50. In FIG. 3, a duplicate active session register 71 is provided in the dynamic proxy server itself.

In alternative arrangements, similar to those depicted in FIGS. 2 and 3, the mobile terminal 10 may have a microbrowser that is itself capable of decoding cHTML (Compact HTML) encoded content, such as the Universal Edition of OpenWave Mobile Browser (for example a terminal that is compatible with the Japanese imode system), or alternatively the terminal has sufficient processing power to run a browser capable of rendering HTML encoded content, for example Microsoft Pocket Internet Explorer or Handspring Blazer. As the terminal 10 is itself capable of interpreting HTML content, and transmitting that content via HTTP using the standard suite of internetworking protocols, there is no need for a WAP gateway 20 to perform any translations, and this component may be omitted.

The dynamic proxy server 70 differs from a standard “firewall” system. In such systems, a list is maintained of user addresses that have access to the data it protects, and what access rights each such user address has. However, in a mobile situation, user addresses are not constant but are allocated to a user only on connection. On reconnection after a break, or when roaming from one physical location to another, a user will be allocated a different IP address. Moreover, IP addresses are re-used. It is therefore necessary to identify whether the current user of a given IP address is authorised to have access to the restricted sites 30.

Two connection processes are illustrated in FIG. 4. The process is similar in each embodiment, and the differences will be explained as they occur. If the system is of the kind shown in FIG. 2, having a WAP gateway 20, communication 100, 102, 201, 309 between the user 10 and the rest of the system is made through a gateway 20, which has been omitted for simplicity.

As in FIG. 1, the mobile terminal 10 of FIG. 2 connects to a network access server (NAS) 60, (step 100) for example by dialling a telephone number associated with the NAS. The mobile terminal initiates handshake communications with the NAS 60, causing the username and password data held on the mobile terminal to be conveyed to the authentication server (RADIUS) 50 (step 101). If this matches with the data held on the authentication server then the address allocation function 59 of the authentication server 50 assigns an IP address to the mobile terminal 10 (step 102), which is stored in a register of active sessions 51 (step 103). The mobile terminal then initiates a communication session with the WAP gateway 20 using the WAP protocol stack. Thus far, the process is conventional.

To make a data request, the mobile terminal 10 communicates a request to the gateway 20, which forwards the IP address of the mobile terminal 10 to the dynamic proxy server 70 (step 201). A standard hypertext transfer protocol (http) request contains much more information than just the requested URL. It also includes information relating to the origin of the request, and in particular the remote (IP) address of the browser 10. A header extraction processor 73 in the dynamic proxy server 70 extracts the IP address of the mobile browser from the header, and passes it to a correlation processor 74 which checks the identity of the user to whom that IP address corresponds (step 203). If the IP address detected does not correspond to that of a WAP gateway, then the correlation processor 74 treats this as the true IP address of the browser 10. However, if the IP address corresponds to that of a WAP gateway (20), then the correlation processor retrieves the true browser IP address from the aforementioned additional field in the header information. The correlation processor 74 in the dynamic proxy server 70 uses the IP address extracted from the Header Extraction processor 73 to search the Active Sessions database 51, 71 and retrieve the corresponding user identity. The correlation processor 74 may use either of the following two methods.

The first method is depicted in FIGS. 2 and 4. In this method, on receipt of a request from the terminal 10 for data from the server 30, the correlation processor 74 transmits the header information (specifically the originating IP address or other user identifier) to the authentication server 50 (step 204). The authentication server 50 retrieves a corresponding user identifier from the active sessions register 51 and returns it to the dynamic proxy server 70, (step 205) where the correlation processor 74 can then determine the access rights for the user 10.

The active sessions register 51 is a dynamic database, which stores details of active users. It stores the details of the IP address allocated by the access server 50 against the User_ID of every active user into the database while they are using the service, and then removes them once the session has been terminated.

In the alternative method, depicted in FIGS. 3 and 4, immediately following authentication of the username and password associated with the terminal 10, the authentication server 50 transmits a user identifier to the dynamic proxy server 70, together with the IP address assigned to the User's mobile terminal, (step 116) thus generating an active sessions register 71, which is a duplicate of the register 51 in the authentication server 50. The correlation processor 74 can then cross-reference any IP address subsequently received from the mobile terminal 10 with the stored IP address (steps 214, 215), to obtain the user identifier for the communication session without recourse to the data stored in the authenticationn server 50.

In the first arrangement authentication is therefore carried out by the authentication server 50. However, in the second arrangement the necessary information is first provided to the dynamic proxy server 70 so that it can perform this function itself. In either case, if the authentication server 50 or node 70 fails to match the ‘unique’ identifier(s) against records 51,71 it holds, or if the mobile terminal 10 has not been configured to forward the correct identifiers, the communication session is terminated.

If a match is found, an access processor 75 uses the user identity to identify whether the requested destination address (url) has restricted access such as a server or an application on a Corporate “Intranet” and, if so, whether the user has access rights (step 206). Access may be to data files that are specific to a corporate intranet, a particular user group within the company, or to an individual user's email server or timesheet facility. The access processor 75 extracts the user identity and then checks the requested address against a “Deny List” database to ensure access is only allowed to valid users. If the requested address is in the list but is not available to the user it generates an error (“Access Denied”) message (step 227). Otherwise, if the requested address is either not in the “Deny List” (which would be the case if it was available to all users) or is listed against the user identity (which would be the case if access is available to a limited group of which the person requesting access is a member) then the user is allowed access to the requested URL. The access processor 75 therefore forwards the request to the appropriate server 30 (step 207). Note that the forwarded request 207 is unchanged, and in particular still carries the same header information. If a proxy address is used, for example by use of a WAP gateway 20, the temporary IP address is the one forwarded.

The server 30 may simply return information requested by the user device 10 without any further authentication, relying on the authentication processes carried out by the dynamic proxy server 70. However, it may personalise the data it returns making use of the active sessions register 51, 71 as follows. If a proxy server 20 is in use, this requires server 30 to have access to the additional header information previously referred to. The server 30 has a header extraction processor 33, and a user correlation processor 34, analogous to those 73, 74 in the dynamic proxy server 70. If a valid HTTP request has been passed from the dynamic proxy server 70 the header extraction processor 33 extracts the IP address of the active session from the HTTP header of the request, (step 303) in the same way that the header extraction processor 73 does in the dynamic proxy server 70, and the correlation processor 34 performs a correlation process similar to that carried out by the dynamic proxy server correlation processor 74. The correlation processor 34 uses the address to search the Active Sessions database 51/71 and retrieve the corresponding user identity, for passing to a Menu Building function 36 (step 304, 305). This retrieves the addresses for the appropriate corporate intranet (step 307), and generates a web page for transmission back to the user device 10 (step 308).

The server 30 may then return the user and/or group options to the mobile terminal 10, via the WAP gateway 20, in the form of a menu from which one or more choices may be selected (step 309). The user's selection can then be conveyed to the dynamic proxy server 70 (acting as a proxy server for the mobile terminal 10), through the WAP gateway 20. The dynamic proxy server 70 uses the URL selected by the user, and restricts user access to only authorised address spaces in the interests of security, to initiate communication with the network. This arrangement also enables athotrised mobile terminals to communicate with hosts without the user knowing the final (destination) IP address. The user may be prompted to enter a PIN or further password before being granted access to the selected network or application.

The present invention provides secure access to private networks (or applications hosted on private networks) based upon the unique identifiers associated with the mobile terminal. This allows a relatively high degree of security to be maintained without causing too much inconvenience to the user.

Unauthorised access to these systems by misuse of a lost or stolen terminal can be prevented by the need to provide a PIN (or password) to access specific networks or applications. The use of specific unique terminal identifiers should reduce the possibility of an authorised user having their details misused (‘spoofed’) by an unauthorised individual. In order to reduce the possibility of a hacker intercepting the specific unique identifiers when they are being conveyed, the conveyed data can be protected over the radio link by WTLS (Wireless Transport Layer Security) as well as any encryption that is provided by the radio bearer (for example the A5 encryption algorithm which is used by GSM systems). SSL (Secure Sockets Layer) protocol is used to protect the data as it is conveyed across the Carriers fixed network.

Whilst being transmitted over the radio link the terminal identifiers are kept secure by the encryption provided by the radio bearer system. In addition, it is possible to provide protection at the application level, using, for example SSL (if the mobile terminal has sufficient processing power and other hardware capabilities as required). In all cases, communication sessions from the dynamic proxy server to the public Internet or the private networks can be protected using SSL or other techniques.

If the IP address changes during a session, or a session ends, the active sessions registers 51, 71 are updated to correspond with the new IP address associated with the terminal 10 and the previous association is deleted to prevent unauthorised access by the next user to be allocated that IP address.

Referring again to FIGS. 2 and 3, in “2.5G” (for example GPRS or D-AMPS+) or “3G” (for example UMTS or CDMA 2000) radio bearer systems communication sessions, the general arrangement is the same as for a dial-in system but sessions are established directly by network routers between a terminal 10 and a gateway 20 referenced by an IP address. There is no separate network access server 60: the network router allocates an IP address when a call is routed. Note that in a packet data system each packet is separately routed, and the IP address may change during the session.

1. A method of providing network access for a mobile terminal, the method comprising the steps of;
(a) receiving one or more terminal-unique identifiers from the mobile terminal (10) at an authentication server (50),
(b) generating a temporary network address for the mobile terminal (10)
(c) storing the unique identifier and temporary network address; and
(d) when access to a network (40) is requested by a mobile terminal (10) through a proxy server (70), retrieving the stored unique identifier corresponding to the temporary network address of the mobile terminal making the request;
(f) searching a database for access rights associated with the retrieved terminal identifier;
(g) allowing the request to be forwarded if the access rights for the retrieved terminal identifier are compatible with the access request.

2. A method according to claim 1, wherein the authentication server (50) transmits the terminal-unique identifiers to a store (71) in the dynamic proxy server (70)

3. A method according to claim 1, wherein the terminal-unique identifiers are stored in a store (51) in the authentication server (50) for retrieval therefrom by the dynamic proxy server (70).

4. A method according to any of claims 1 to 3, wherein the dynamic proxy server communicates with the mobile terminal via a WAP gateway (20).

5. A method according to any of claims 1 to 4, wherein the one or more terminal-unique identifiers received by the authentication server (50) are unique to the mobile terminal data carrier.

6. A method according to claim 5, wherein the one or more terminal-unique identifiers received by the authentication server (50) are unique to a subscriber identity module (SIM) card held by the terminal (10).

7. A method according to any of claim 1 to claim 4, wherein the one or more unique terminal identifiers received by the authentication server (50) are unique to the terminal hardware (10).

8. A method according to any of claim 1 to claim 7, wherein the network address transmitted to the dynamic proxy server (70) is associated with the one or more terminal identifiers sent to the authentication server (50).

9. A method according to any of claim 1 to claim 8, wherein the network address transmitted to the dynamic proxy server (70) is chosen from a defined range of network addresses.

10. A communications network comprising an authentication server (50) having address allocation means (59) for receiving data from a mobile terminal (10), said data comprising terminal-unique identifiers and allocating a temporary network address to the mobile terminal (10)
storage means (51, 71) for storing the network address and the terminal-unique identifier for subsequent retrieval,
a dynamic proxy server (70), the dynamic proxy server having identification means (73), correlation means (74), and validation means (75)
the identification means (73) being arranged to identify the network address from which a data request originates,
the correlation means (74) being arranged to search the database (51,71) of network addresses and, if the search indicates a match, retrieve the terminal-unique identifier corresponding to the network address from the database (51, 71),
and the validation means (75) being arranged for searching a database for access rights associated with the retrieved terminal identifier, and forwarding the data request to the requested destination if the access rights for the retrieved terminal identifier are compatible with the access request.

11. A communications network according to claim 10, wherein the database (51) is part of the authentication server (50).

12. A communications network according to claim 10, in which the authentication server (50) is in communication with the dynamic proxy server (70) such that, in use, the terminal-unique identifiers are communicated to the authentication server (50) from the mobile terminal via the dynamic proxy server (70).

13. A communications network according to claim 10, 11, or 12 further comprising a WAP gateway (20), which is in communication with the dynamic proxy server (70) such that, in use, the mobile terminal (10) communicates with the dynamic proxy server (70) via the gateway (20).
